(19) United States
(12) Patent Application Publication
(10) Pub. No.: US 2026/0263883 A1
(43) Pub. Date: Sep. 10, 2026

(54) BAT BASED ON SILICONE DAMPING AND METHOD FOR MANUFACTURING THE SAME

(71) Applicant: Tianchang Zhengmu Technology Co., Ltd., Anhui (CN)

(72) Inventors: Liangzheng ZHOU, Anhui (CN); Shijuan Ji, Anhui (CN); Yulian Song, Anhui (CN); Decai Zeng, Anhui (CN); Gencai Chen, Anhui (CN)

(73) Assignee: Tianchang Zhengmu Technology Co., Ltd., Anhui (CN)

(21) Appl. No.: 19/661,596

(22) Filed: Apr. 28, 2026

Related U.S. Application Data
(63) Continuation of application No. PCT/CN2024/134856, filed on Nov. 27, 2024.

(30) Foreign Application Priority Data
Nov. 21, 2024 (CN) 202411668684.2

(51) Int. Cl. A63B 59/54; A63B 59/51

(52) U.S. Cl. CPC A63B 59/54; A63B 59/51; A63B 2209/10

(57) ABSTRACT

The present disclosure discloses a bat based on silicone damping and a method for manufacturing the same. The bat includes a grip handle, a silicone sleeve, and a hitting barrel having an opening at a lower end; an upper end of the grip handle is provided with a connecting section, the silicone sleeve is sleeved on the connecting section of the grip handle, and the connecting section is bonded to an inner side of the silicone sleeve through a first adhesive layer; and a lower end of an inner wall of the hitting barrel is bonded to an outer side of the silicone sleeve through a second adhesive layer. The bat of the present disclosure may achieve excellent damping performance by disposing the silicone sleeve having a damping effect between the grip handle and the hitting barrel and bonding the silicone sleeve through a silicone adhesive.

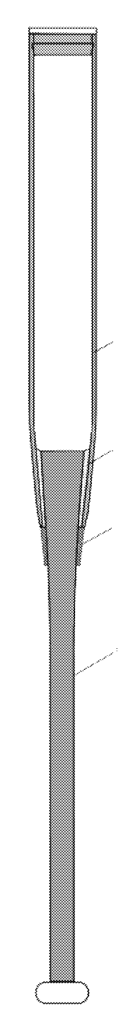

### CROSS-REFERENCE TO RELATED APPLICATION

The present application is a continuation of international application of PCT patent application PCT/CN2024/134856, filed on November 27, 2024, which claims the priority benefit of China application No. 202411668684.2, filed with China National Intellectual Property Administration on November 21, 2024 and titled “BAT BASED ON SILICONE DAMPING AND METHOD FOR MANUFACTURING THE SAME,” the entire content of which is incorporated herein by reference.

### BACKGROUND

### TECHNICAL FIELD

The present disclosure relates to the technical field of sports equipment manufacturing, and in particular to a bat based on silicone damping and a method for manufacturing the same.

### DESCRIPTION OF RELATED ART

Baseball and softball are widely popular ball sports, in which a bat is used to hit a ball for offensive and defensive confrontation. However, when a player hits the ball, an impact force generated by the ball contacting a bat barrel and being hit away is transmitted along the barrel to a hand holding the bat, causing great discomfort to the player's hand and even severe pain, which is inconvenient for the player's daily practice. To solve this problem, there is a need to develop a bat having a damping effect.

### SUMMARY

Based on the technical problem existing in the background, the present disclosure provides a bat based on silicone damping and a method for manufacturing the same.

The present disclosure provides a bat based on silicone damping, where the bat includes a grip handle, a silicone sleeve, and a hitting barrel having an opening at a lower end; an upper end of the grip handle is provided with a connecting section, the silicone sleeve is sleeved on the connecting section of the grip handle, the connecting section is bonded to an inner side of the silicone sleeve through a first adhesive layer, and a lower end of an inner wall of the hitting barrel is bonded to an outer side of the silicone sleeve through a second adhesive layer;

the silicone sleeve is prepared from the following raw materials in parts by mass: 100 parts of methyl vinyl silicone rubber gum, 30-40 parts of fumed silica, 0.3-0.8 part of a vulcanizing agent, 1-2 parts of amino silicone oil, and 0.3-0.5 part of cardanol glycidyl ether;

the first adhesive layer and the second adhesive layer are formed by curing a silicone adhesive, and the silicone adhesive includes Component A and Component B; Component A includes the following raw materials in parts by mass: 100 parts of an acrylate-modified organosilicon resin, 5-10 parts of methyl silicone oil, and 30-50 parts of an inorganic filler; Component B includes the following raw materials in parts by mass: 10-20 parts of methyl silicone oil, 5-10 parts of a silane coupling agent KH-550, 2-5 parts of ethyl orthosilicate, and 0.5-1 part of an organotin catalyst; and a mass ratio of Component A to Component B is 3-5:1; and

a method for preparing the acrylate-modified organosilicon resin includes: adding α,ω-dihydroxypolydimethylsiloxane, acrylic acid, methyl methacrylate, and hydroxyethyl methacrylate to a solvent, and then dropwise adding an initiator solution under nitrogen protection for a polymerization reaction to obtain the acrylate-modified organosilicon resin, where a mass ratio of the α,ω-dihydroxypolydimethylsiloxane, the acrylic acid, the methyl methacrylate, the hydroxyethyl methacrylate, and the initiator is 1:0.2-0.3:1-1.5:0.8-1.2:0.03-0.05.

Preferably, the methyl vinyl silicone rubber gum has a vinyl content of 0.1%-0.3% and a molecular weight of 500,000-700,000.

Preferably, the vulcanizing agent is a dicumyl peroxide or 2,5-dimethyl-2,5-di(tert-butylperoxy)hexane vulcanizing agent.

In the present disclosure, the cardanol glycidyl ether may be commercially available or prepared by a conventional method in the art, for example:

mixing cardanol, epichlorohydrin and benzyltriethylammonium chloride uniformly, then under nitrogen protection, allowing the components to react at a constant temperature of 70-90°C for 4-6 h, cooling to 55-65°C, then adding a sodium hydroxide solution with a mass fraction of 30-40%, allowing the mixture to react at the constant temperature for 3-4 h, washing a resulting solution with water to neutrality after cooling, then separating an organic phase, and removing water and epichlorohydrin from the organic phase by rotary evaporation to obtain the cardanol glycidyl ether; where a mass ratio of the cardanol, the epichlorohydrin, the benzyltriethylammonium chloride, and the sodium hydroxide is 100:200-300:0.5-1:15-20.

Preferably, a method for preparing the silicone sleeve includes: adding the methyl vinyl silicone rubber gum and the fumed silica to a kneader, kneading the mixture at 30-40°C for 10-20 min, then heating the mixture to 60-80°C, adding the amino silicone oil and the cardanol glycidyl ether and kneading the components for 20-30 min, then adding the vulcanizing agent and continuing kneading for 5-10 min to obtain a mixed rubber compound; and adding the mixed rubber compound to a mold, and vulcanizing and molding the mixed rubber compound at 140-160°C and 5-8 MPa for 5-10 min to obtain the silicone sleeve.

Preferably, the inorganic filler is at least one of fumed silica, talc powder, calcium carbonate, and barium sulfate.

Preferably, the polymerization reaction is performed at a temperature of 70-80°C for 2-4 h.

Preferably, the hitting barrel is made of aluminum alloy or carbon fiber.

Preferably, the bat further includes a retaining ring, a lower portion of the grip handle is provided with a threaded section connected to the connecting section, and the retaining ring is fixedly connected to the threaded section through the thread and configured to limit an end of the hitting barrel.

Preferably, the retaining ring has an internal thread and is threadedly engaged with the threaded section of the grip handle.

Preferably, a method for manufacturing the bat includes the following steps:

uniformly applying the silicone adhesive on the connecting section at the upper end of the grip handle, then sleeving the silicone sleeve onto the connecting section, and curing the silicone adhesive to form the first adhesive layer; uniformly applying the silicone adhesive on the outer side of the silicone sleeve, then sleeving the lower end of the inner wall of the hitting barrel onto the silicone sleeve, and curing the silicone adhesive to form the second adhesive layer; and then screwing the retaining ring onto the threaded section of the grip handle to obtain the bat.

Beneficial effects of the present application are as follows.

The bat of the present disclosure achieves excellent damping performance by disposing the silicone sleeve having a damping effect between the grip handle and the hitting barrel and bonding the silicone sleeve through the silicone adhesive. By adding appropriate amounts of amino silicone oil and cardanol glycidyl ether to the raw materials of the silicone sleeve, crosslinking occurs between the amino silicone oil and the cardanol glycidyl ether during the preparation of the silicone rubber, and more active groups and flexible fatty long chains are introduced into the rubber compound, thereby improving the toughness and interfacial bonding strength of the rubber compound, and enhancing the adhesion between the silicone sleeve and the hitting barrel, as well as between the silicone sleeve and the adhesive layer formed by the silicone adhesive. Using appropriate acrylate monomers, such as acrylic acid, methyl methacrylate, and hydroxyethyl methacrylate, to modify the base material α,ω-dihydroxypolydimethylsiloxane of the silicone adhesive improves the wettability and adhesion of the silicone adhesive to the silicone sleeve and the hitting barrel. Thus, the grip handle and the hitting barrel of the bat are tightly bonded together through the silicone sleeve and the adhesive layer formed by the silicone adhesive, and the adhesive bonding strength between the silicone sleeve and the adhesive layer, the handle, and the hitting barrel is very strong, such that they are not easily peeled off under the vibration generated when the bat hits a ball, thereby ensuring that the damping effect is not compromised. Therefore, a long-term damping effect may be achieved.

### BRIEF DESCRIPTION OF DRAWINGS

FIGURE is a schematic view of a bat based on silicone damping provided by the present disclosure. Reference numerals in FIGURE: 1-grip handle; 2-hitting barrel; 3-silicone sleeve; and 4-retaining ring.

### DESCRIPTION OF EMBODIMENTS

Below, the technical solution of the present disclosure is described in detail by means of specific embodiment.

In the following embodiments and comparative examples, the methyl vinyl silicone rubber gum has a vinyl content of 0.23% and a molecular weight of 600,000.

### Embodiment 1

A bat based on silicone damping is provided, where the bat includes a grip handle 1, a silicone sleeve 3, a retaining ring 4, and an aluminum alloy hitting barrel 2 having an opening at a lower end; an upper end of the grip handle 1 is provided with a connecting section, the silicone sleeve 3 is sleeved on the connecting section of the grip handle, the connecting section is bonded to an inner side of the silicone sleeve 3 through a first adhesive layer, and a lower end of an inner wall of the hitting barrel 2 is bonded to an outer side of the silicone sleeve 3 through a second adhesive layer; and a lower portion of the grip handle 1 is provided with a threaded section connected to the connecting section, the retaining ring 4 has an internal thread, is threadedly engaged with the threaded section of the grip handle 1, and is fixedly connected to the threaded section through the thread and configured to limit an end of the hitting barrel 2.

The silicone sleeve 3 was prepared from the following raw materials in parts by mass: 100 parts of methyl vinyl silicone rubber gum, 35 parts of fumed silica, 0.5 part of a 2,5-dimethyl-2,5-di(tert-butylperoxy)hexane vulcanizing agent, 1.5 parts of amino silicone oil, and 0.4 part of cardanol glycidyl ether. A method for preparing the silicone sleeve 3 included: the methyl vinyl silicone rubber gum and the fumed silica were added to a kneader, kneaded at 35°C for 15 min, and then heated to 70°C, the amino silicone oil and the cardanol glycidyl ether were added and these components were kneaded for 25 min, then the 2,5-dimethyl-2,5-di(tert-butylperoxy)hexane vulcanizing agent was added, and kneading was continued for 8 min to obtain a mixed rubber compound; and the mixed rubber compound was added to a mold, and vulcanized and molded at 155°C and 7 MPa for 6 min to obtain the silicone sleeve.

A method for preparing the cardanol glycidyl ether included: cardanol, epichlorohydrin and benzyltriethylammonium chloride were mixed uniformly, then under nitrogen protection, allowed to react at a constant temperature of 80°C for 5 h, and cooled to 60°C, then a sodium hydroxide solution with a mass fraction of 30% was added, the mixture was allowed to react at the constant temperature for 3 h, a resulting solution was washed with water to neutrality after cooling, then an organic phase was separated, and water and epichlorohydrin were removed from the organic phase by rotary evaporation to obtain the cardanol glycidyl ether; where a mass ratio of the cardanol, the epichlorohydrin, the benzyltriethylammonium chloride, and the sodium hydroxide was 100:200:0.5:15.

The first adhesive layer and the second adhesive layer were formed by curing a silicone adhesive, and the silicone adhesive included Component A and Component B; Component A included the following raw materials in parts by mass: 100 parts of an acrylate-modified organosilicon resin, 8 parts of methyl silicone oil, and 40 parts of fumed silica; Component B included the following raw materials in parts by mass: 15 parts of methyl silicone oil, 8 parts of a silane coupling agent KH-550, 3 parts of ethyl orthosilicate, and 0.8 part of dibutyltin dilaurate; and a mass ratio of Component A to Component B was 4:1.

A method for preparing the acrylate-modified organosilicon resin included: α,ω-dihydroxypolydimethylsiloxane, acrylic acid, methyl methacrylate, and hydroxyethyl methacrylate were added to ethyl acetate, and then a solution of azobisisobutyronitrile in ethyl acetate was dropwise added under nitrogen protection, and a polymerization reaction was performed at 75°C for 3 h to obtain the acrylate-modified organosilicon resin, where a mass ratio of the α,ω-dihydroxypolydimethylsiloxane, the acrylic acid, the methyl methacrylate, the hydroxyethyl methacrylate, and the azobisisobutyronitrile was 1:0.25:1.25:1:0.04.

A method for manufacturing the above bat included the following steps:

the silicone adhesive was uniformly applied on the connecting section at the upper end of the grip handle 1, then the silicone sleeve 3 was sleeved onto the connecting section, and the silicone adhesive was cured for 12 h to form the first adhesive layer; the silicone adhesive was uniformly applied on the outer side of the silicone sleeve 3, then the lower end of the inner wall of the aluminum alloy hitting barrel 2 was sleeved onto the silicone sleeve 3, and the silicone adhesive was cured at room temperature for 12 h to form the second adhesive layer; and then the retaining ring 4 was screwed onto the threaded section of the grip handle 1 to obtain the bat.

### Embodiment 2

Embodiment 2 differs from Embodiment 1 only in the silicone sleeve 3.

The silicone sleeve 3 of Embodiment 2 was prepared from the following raw materials in parts by mass: 100 parts of methyl vinyl silicone rubber gum, 30 parts of fumed silica, 0.3 part of a 2,5-dimethyl-2,5-di(tert-butylperoxy)hexane vulcanizing agent, 1 part of amino silicone oil, and 0.3 part of cardanol glycidyl ether. A method for preparing the silicone sleeve 3 included: the methyl vinyl silicone rubber gum and the fumed silica were added to a kneader, kneaded at 35°C for 15 min, and then heated to 70°C, the amino silicone oil and the cardanol glycidyl ether were added and these components were kneaded for 25 min, then the 2,5-dimethyl-2,5-di(tert-butylperoxy)hexane vulcanizing agent was added, and kneading was continued for 8 min to obtain a mixed rubber compound; and the mixed rubber compound was added to a mold, and vulcanized and molded at 155°C and 7 MPa for 6 min to obtain the silicone sleeve.

### Embodiment 3

Embodiment 3 differs from Embodiment 1 only in the silicone adhesive.

The silicone adhesive of Embodiment 3 included Component A and Component B; Component A included the following raw materials in parts by mass: 100 parts of an acrylate-modified organosilicon resin, 5 parts of methyl silicone oil, and 30 parts of fumed silica; Component B included the following raw materials in parts by mass: 10 parts of methyl silicone oil, 5 parts of a silane coupling agent KH-550, 2 parts of ethyl orthosilicate, and 0.5 part of dibutyltin dilaurate; and a mass ratio of Component A to Component B was 3:1.

A method for preparing the acrylate-modified organosilicon resin included: α,ω-dihydroxypolydimethylsiloxane, acrylic acid, methyl methacrylate, and hydroxyethyl methacrylate were added to ethyl acetate, and then a solution of azobisisobutyronitrile in ethyl acetate was dropwise added under nitrogen protection, and a polymerization reaction was performed at 75°C for 3 h to obtain the acrylate-modified organosilicon resin, where a mass ratio of the α,ω-dihydroxypolydimethylsiloxane, the acrylic acid, the methyl methacrylate, the hydroxyethyl methacrylate, and the azobisisobutyronitrile was 1:0.2:1:0.8:0.03.

### Comparative Example 1

Comparative Example 1 differs from Embodiment 1 only in the silicone sleeve 3.

The silicone sleeve 3 of Comparative Example 1 was prepared from the following raw materials in parts by mass: 100 parts of methyl vinyl silicone rubber gum, 35 parts of fumed silica, and 0.5 part of a 2,5-dimethyl-2,5-di(tert-butylperoxy)hexane vulcanizing agent. A method for preparing the silicone sleeve 3 included: the methyl vinyl silicone rubber gum and the fumed silica were added to a kneader, kneaded at 35°C for 15 min, then heated to 70°C, and continuously kneaded for 25 min, then the 2,5-dimethyl-2,5-di(tert-butylperoxy)hexane vulcanizing agent was added, and kneading was continued for 8 min to obtain a mixed rubber compound; and the mixed rubber compound was added to a mold, and vulcanized and molded at 155°C and 7 MPa for 6 min to obtain the silicone sleeve.

### Comparative Example 2

Comparative Example 2 differs from Embodiment 1 only in the silicone adhesive.

The silicone adhesive of Comparative Example 2 included Component A and Component B; Component A included the following raw materials in parts by mass: 100 parts of an organosilicon resin, 8 parts of methyl silicone oil, and 40 parts of fumed silica; Component B included the following raw materials in parts by mass: 15 parts of methyl silicone oil, 8 parts of a silane coupling agent KH-550, 3 parts of ethyl orthosilicate, and 0.8 part of dibutyltin dilaurate; a mass ratio of Component A to Component B was 4:1; and the organosilicon resin was α,ω-dihydroxypolydimethylsiloxane.

### Test Example

A professional softball player used the bats of Embodiment 1 and Comparative Examples 1-2 respectively for hitting practice 1,500 times, with a practice period of 30 days, hitting 50 times per day. After completing 1,500 hitting practices, the used bats were subjected to a sensory evaluation test for damping. A test method was as follows: the bat was used to hit a ball 20 times, and the hand discomfort was evaluated. Evaluation results show that the bat of Embodiment 1 still maintained excellent damping performance after 1,500 hitting practices, and the player did not feel discomfort in the hand after hitting the ball 20 times; whereas the bats of Comparative Examples 1-2 had deteriorated damping effects after 1,500 hitting practices, and the player felt significant discomfort in the hand after hitting the ball 20 times. This is because the silicone sleeve formulation of Comparative Example 1 did not contain amino silicone oil and cardanol glycidyl ether, resulting in insufficient toughness and interfacial bonding strength of the obtained silicone sleeve. Under the influence of vibration during hitting after long-term practice, a certain degree of peeling occurred between the silicone sleeve and the adhesive layer, affecting the damping effect. As for Comparative Example 2, the silicone adhesive was not modified with acrylates, and its adhesion and wettability were insufficient. Similarly, peeling occurred under the influence of vibration after long-term hitting, leading to a decrease in the damping effect.

The above descriptions are only preferred embodiments of the present disclosure, but the protection scope of the present disclosure is not limited thereto. Any equivalent substitutions or modifications made by those skilled in the art within the technical scope disclosed in the present disclosure according to the technical solutions and inventive concepts of the present disclosure should fall within the protection scope of the present disclosure.

What is claimed is:

1. A bat based on silicone damping, comprising:
a grip handle, wherein an upper end of the grip handle is provided with a connecting section;
a silicone sleeve, wherein the silicone sleeve is sleeved on the connecting section of the grip handle; and
a hitting barrel having an opening at a lower end, wherein:
the connecting section is bonded to an inner side of the silicone sleeve through a first adhesive layer, and a lower end of an inner wall of the hitting barrel is bonded to an outer side of the silicone sleeve through a second adhesive layer;
the silicone sleeve is prepared from the following raw materials in parts by mass: 100 parts of methyl vinyl silicone rubber gum, 30-40 parts of fumed silica, 0.3-0.8 part of a vulcanizing agent, 1-2 parts of amino silicone oil, and 0.3-0.5 part of cardanol glycidyl ether;
the first adhesive layer and the second adhesive layer are formed by curing a silicone adhesive, and the silicone adhesive comprises Component A and Component B, wherein Component A comprises the following raw materials in parts by mass: 100 parts of an acrylate-modified organosilicon resin, 5-10 parts of methyl silicone oil, and 30-50 parts of an inorganic filler, and Component B comprises the following raw materials in parts by mass: 10-20 parts of methyl silicone oil, 5-10 parts of a silane coupling agent KH-550, 2-5 parts of ethyl orthosilicate, and 0.5-1 part of an organotin catalyst; and a mass ratio of Component A to Component B is 3-5:1; and
the acrylate-modified organosilicon resin is prepared by the following steps comprising:
adding α,ω-dihydroxypolydimethylsiloxane, acrylic acid, methyl methacrylate, and hydroxyethyl methacrylate to a solvent, and then dropwise adding an initiator solution under nitrogen protection for a polymerization reaction to obtain the acrylate-modified organosilicon resin, wherein a mass ratio of the α,ω-dihydroxypolydimethylsiloxane, the acrylic acid, the methyl methacrylate, the hydroxyethyl methacrylate, and the initiator is 1:0.2-0.3:1-1.5:0.8-1.2:0.03-0.05.

2. The bat based on silicone damping according to claim 1, wherein the methyl vinyl silicone rubber gum has a vinyl content of 0.1%-0.3% and a molecular weight of 500,000-700,000.

3. The bat based on silicone damping according to claim 1, wherein the vulcanizing agent is a dicumyl peroxide or 2,5-dimethyl-2,5-di(tert-butylperoxy)hexane vulcanizing agent.

4. The bat based on silicone damping according to claim 1, wherein the silicone sleeve is prepared by the following steps comprising:
adding the methyl vinyl silicone rubber gum and the fumed silica to a kneader, kneading the mixture at 30-40°C for 10-20 min, then heating the mixture to 60-80°C, adding the amino silicone oil and the cardanol glycidyl ether and kneading the components for 20-30 min, then adding the vulcanizing agent and continuing kneading for 5-10 min to obtain a mixed rubber compound; and
adding the mixed rubber compound to a mold, and vulcanizing and molding the mixed rubber compound at 140-160°C and 5-8 MPa for 5-10 min to obtain the silicone sleeve.

5. The bat based on silicone damping according to claim 1, wherein the inorganic filler is at least one of fumed silica, talc powder, calcium carbonate, and barium sulfate.

6. The bat based on silicone damping according to claim 1, wherein the polymerization reaction is performed at a temperature of 70-80°C for 2-4 h.

7. The bat based on silicone damping according to claim 1, wherein the hitting barrel is made of aluminum alloy or carbon fiber.

8. The bat based on silicone damping according to claim 1, further comprising:
a retaining ring, wherein a lower portion of the grip handle is provided with a threaded section connected to the connecting section, and the retaining ring is fixedly connected to the threaded section through the thread and configured to limit an end of the hitting barrel.

9. The bat based on silicone damping according to claim 8, wherein the retaining ring has an internal thread and is threadedly engaged with the threaded section of the grip handle.

10. A method for manufacturing the bat based on silicone damping according to claim 8, comprising the following steps:
uniformly applying the silicone adhesive on the connecting section at the upper end of the grip handle, then sleeving the silicone sleeve onto the connecting section, and curing the silicone adhesive to form the first adhesive layer;
uniformly applying the silicone adhesive on the outer side of the silicone sleeve, then sleeving the lower end of the inner wall of the hitting barrel onto the silicone sleeve, and curing the silicone adhesive to form the second adhesive layer; and then
screwing the retaining ring onto the threaded section of the grip handle to obtain the bat.
